(19) United States
(12) Patent Application Publication
(10) Pub. No.: US 2010/0059546 A1
(43) Pub. Date: Mar. 11, 2010

(54) HAND-OPERATED DISPENSER FOR PASTE-LIKE TO FLUID SUBSTANCES AND LINKING RECEPTACLE THEREFOR

(75) Inventor: Haluk Cimentepe, Villingen-Schwennigen (DE)

Correspondence Address: COLLARD & ROE, P.C., 1077 NORTHERN BOULEVARD, ROSLYN, NY, 11576, US

(73) Assignee: MEGAPLAST GMBH & CO. KG, VILLINGEN-SCHWENNINGEN (DE)

(21) Appl. No.: 12/448,065

(22) PCT Filed: Dec. 5, 2007
(86) PCT No.: PCT/EP2007/063358

§ 371 Date: Jun. 5, 2009

(30) Foreign Application Priority Data
Dec. 6, 2006 (DE) 10-2006-057-794.9
Mar. 22, 2007 (DE) 10-2007013723.2

(51) Int. Cl. B67D 7/08; B67D 7/70; B67D 7/64; B65D 37/00

(52) U.S. Cl. 222/135; 222/207; 222/136; 222/145.3

(57) ABSTRACT

The invention relates to a hand-operated dispenser (1) for highly viscous to fluid substances with a pumping chamber (17) and with at least one outlet valve (12) and a storage chamber with a feeding piston (5), wherein the dispenser (1) is designed for the output of two different substances, a first substance (4) and a second substance (22). The second substance (22) is brought out by the pressure of the first substance (4). To develop a dispenser of this type for most efficient use, it is proposed that a movable separating body (T) be arranged between the first substance (4) and the second substance (22).

The invention relates, in first instance, to a hand-operated dispenser for paste-like to fluid substances, having a pumping chamber and at least one outlet valve and also a storage chamber with a feeding piston, the dispenser being configured for dispensing two different substances, a first substance and second substance.

DE 10222356 A1 discloses a dispenser of the type in question in which two different paste-like substances are disposed one above the other in a container.

It is an object of the invention to develop a dispenser of the type in question in a functionally advantageous manner.

This object is achieved first and foremost by a dispenser having the features of claim 1, this being based on a movable separating body being disposed between the first substance and the second substance.

The separating body prevents a possible reaction between the different substances in the container. The two different substances can be stored such that they are spatially separated from one another up to their discharge. They can be brought into contact with one another for example prior to discharge, but also, if appropriate, for the first time only following discharge. It is even possible here, in first instance, for the separating body to be fitted in a movable or fixed manner. It is preferred for the separating body to be fitted in a movable manner.

In the case of a separating body which is fitted and/or disposed in a movable manner, the separating body is displaced, for example in the direction of the outlet opening, as the substance is being discharged. As a result of the displacement of the separating body, the pressure can be transmitted from the first substance to the second substance and the second substance can be, for example, delivered thereby.

As an alternative, or in addition, to the above described configuration of a dispenser, the invention also proposes, in respect of a functionally advantageous embodiment, that the second substance is introduced into the first substance downstream of the outlet valve. The substances are thus ultimately applied to a surface together, although the first and second substances are only brought together for the first time downstream of the outlet valve of the pumping chamber.

Since the second substance is introduced into the first substance for the first time downstream of the outlet valve of the pumping chamber, it is not necessary for the second substance also to pass through the pumping chamber of the dispenser. This makes it possible to take account, for example, of the sensitivity of the substance in respect of mechanical working or kneading. However, it is also possible in this way, if for example the substances react with one another to a certain extent, to achieve the situation where the substances react for the first time downstream of the outlet valve of the pumping chamber. Accordingly, it is also the case that it is not necessary, although it is possible, for the second substance to be disposed upstream of the pumping chamber, as seen in the flow direction of the (first) substance. However, in the case of such an arrangement upstream of the pumping chamber, it may also be delivered, as it were, over a bypass route to the pumping chamber.

In a further embodiment, which can be realized as an alternative to, or in combination with, the first and/or second configurations, the invention also proposes that the second substance is accommodated in a second receptacle, which can be linked to the receptacle in order for the second substance to be discharged. Such a configuration means that a dispenser can be operated in first instance selectively for discharge of just one substance or for discharge of two substances, without the actual basic body of the dispenser, which thus has the storage chamber and the pumping chamber, being altered or without anything having to be introduced into this basic body. Furthermore, it is also possible in this way for the first substance to be brought into contact with different quantities of the second substance, namely by way of smaller or larger linking receptacles. As the first substance is being dispensed, it is also possible for the linking receptacle to be changed, so that, over a first period of time, a first type of second substance is discharged together with the first substance and, over a second period of time, a second type of second substance is discharged together with the first substance.

The dispenser accommodates, for example, a basic substance, which can be mixed with different additional substances, which are accommodated in the linking receptacle.

The rest of the features explained may be a development of one of the embodiments described above, but may also, in principle, be important independently thereof.

It is thus preferred for the outlet valve of the pumping chamber to be disposed at the location of separation between the two receptacles or chambers for the different substances. In the case of a linkable receptacle, the latter can easily be removed or separated from the actual dispenser without the second substance then escaping from the dispenser in an uncontrolled manner.

The ratio of the two substances may be selected such that the second substance is provided in the linking container and/or the dispenser until the first substance is emptied. It is thus possible for a dispenser to be operated using one and the same linking receptacle until the first substance is emptied. As has basically already been mentioned, it may also, however, be provided that a dispenser is operated with a linking receptacle which is provided only for some of the first substance. Nevertheless, once it has been emptied, it can remain on the dispenser, in which case the linking receptacle also has only the first substance passing through it.

Furthermore it is preferred for the separating body to be in the form of a feeding piston, the only thing being in this case that it is preferably used atypically insofar as, rather than being moved by negative pressure or suction, the separating body or the feeding piston is moved by the pressure of the first substance on its side which is directed away from the outlet opening of the dispenser.

The separating body is also preferably adapted in shape to the basic contour of the linking receptacle, the linking receptacle having, in a preferred configuration, a round cross-section.

More specifically, the separating body can preferably be displaced relative to a discharge tube. It is possible here for the discharge tube to be disposed centrally in the linking receptacle and thus to pass through the separating body. The separating body, for example, in the abovementioned configuration of a piston, thus has an opening, for example, a central opening, through which the discharge tube passes. The discharge tube here forms a kind of separating-body-guiding or piston-guiding tube.

The discharge tube is also advantageous insofar as the first substance can pass through it and, on account of an opening in the discharge tube, the second substance is then mixed with the first substance—for the first time—upstream of the outlet opening. Irrespective of this specific configuration, however, the measure which allows the first substance and the second substance to come into contact with one another for the first time immediately upstream of the outlet opening is also of fundamental importance.

As has likewise basically been mentioned above, it is preferred for the separating body to be disposed only on the far side of the outlet valve, associated with the pumping chamber of the dispenser, as seen in the flow direction of the substance. It is also preferred here for the basic flow direction of the substance in the receptacle, for example linking receptacle, for the second substance and the storage space for the first substance to be angled in relation to one another. Further preferably, an axis running along the longitudinal extent of the dispenser has an angle of 90° in relation to the longitudinally running axis of the chamber for the second substance and/or of the linking receptacle.

It is also preferred for the linking receptacle to have a dedicated inlet valve for the second substance. Through this inlet valve, the first substance of the first receptacle can penetrate into the linking receptacle—for the first time—following passage through the outlet valve of the dispenser. This further assists the advantageous well-defined separability of the linking receptacle and dispenser which has also already been mentioned above.

The inlet and/or the outlet valve are/is preferably formed as an elastic self-closing valve. It is thus basically possible to use the same or similar inlet valves and/or outlet valves in the pumping chamber and the linking receptacle. Both the inlet valve of the linking receptacle and the outlet valve of the dispenser can be operated by the pressure of the first substance. It is only the restoring force of the valves, which are formed from elastic material, which displaces the latter into their closing position as the pressure decreases.

In the case of the linking receptacle, the latter can be connected to the first receptacle by a push-in connection. This is preferably configured such that it is made in a direction transverse or perpendicular to the through-passage direction of the first and/or second substance in the linking receptacle. Attachment or removal thus takes place, as it were, with a shearing movement, which also facilitates convenient separation.

In contrast to this, it is also possible for the linking receptacle to be latched to the dispenser, for example via a latching means which can be released by the push of a button. Irrespective of the configurations described, it is also possible for the linking receptacle to be provided with the dispenser such that it cannot be released during operation and/or even to be formed partially integrally with the dispenser.

The invention also relates to a linking receptacle for linking to a dispenser, in particular to a dispenser according to one of the abovedescribed configurations. The linking receptacle here is distinguished in that it contains a (second) paste-like substance and has an inlet opening and an outlet opening.

In the case of such a linking receptacle, it has proven advantageous for at least the inlet opening to be closed by a valve. Furthermore, it may also be provided that the outlet opening is sealed, for example, with a tamper-evident seal. The inlet valve achieves the situation where it is not possible for any substance to escape from the linking receptacle until the linking receptacle is fitted to a dispenser and/or during removal of the linking receptacle from a dispenser. The inlet valve likewise prevents contaminants from being able to pass into the linking receptacle prior to its use.

The linking receptacle advantageously has a discharge tube, which is formed in it and extends as far as the outlet opening of the linking receptacle. Furthermore, the linking receptacle preferably contains a separating body which can be displaced in the direction of discharge. This separating body may, as has also basically already been mentioned, be in the form of a feeding piston. The feeding piston here is configured such that the linking receptacle can be emptied more or less completely of the second substance, the second substance preferably being introduced via apertures into the strand of first substance, which is forced through the discharge tube. This results in a substance being discharged which has circumferentially distributed stripes of second substance. The number of stripes of second substance on the strand of first substance depends on the number of apertures in the discharge tube.

The invention, furthermore, will be explained in more detail hereinbelow with reference to the accompanying drawing, which merely illustrates an exemplary embodiment and in which:

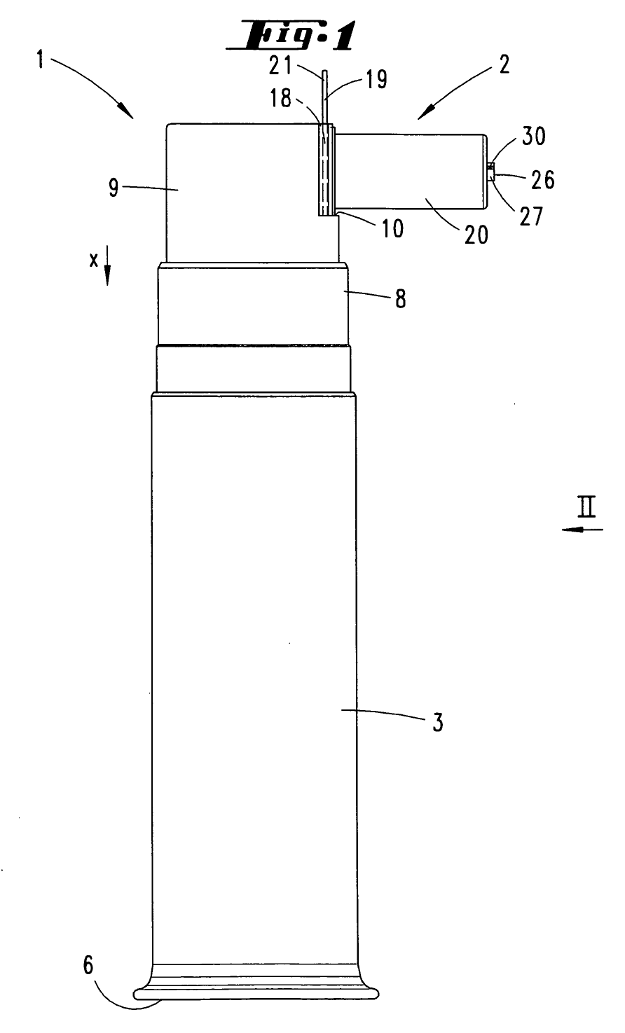

FIG. 1 shows a front view of a possible configuration of a dispenser with a linking receptacle in the inactive position;

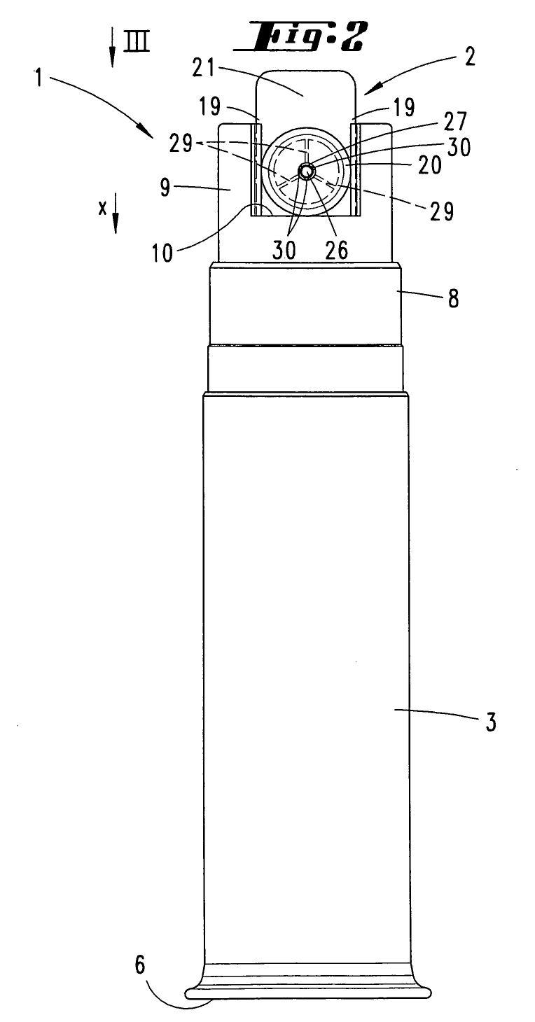

FIG. 2 shows a side view corresponding to viewing direction II from FIG. 1;

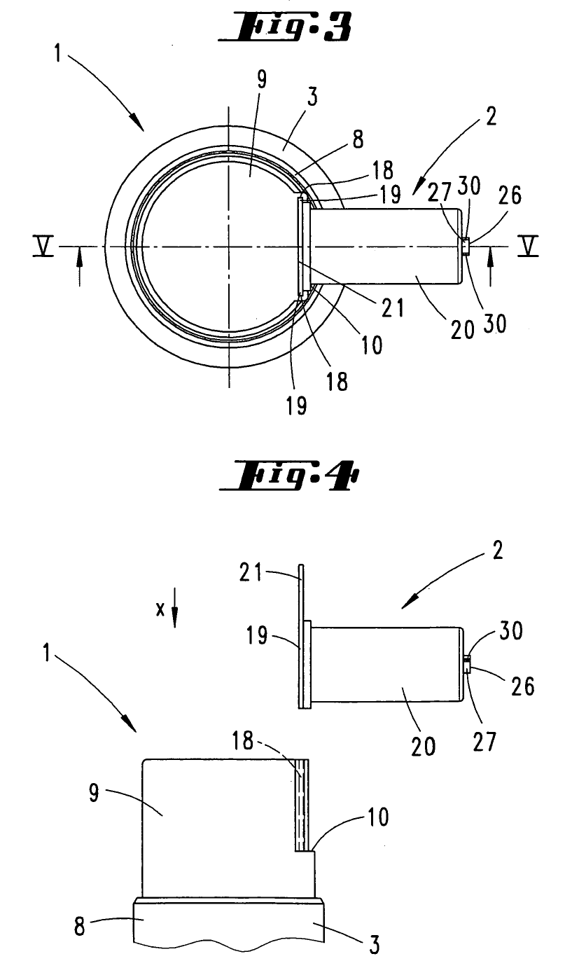

FIG. 3 shows a plan view corresponding to viewing direction III from FIG. 2;

FIG. 4 shows a view corresponding to FIG. 1, although in this case the linking receptacle has been separated from the dispenser;

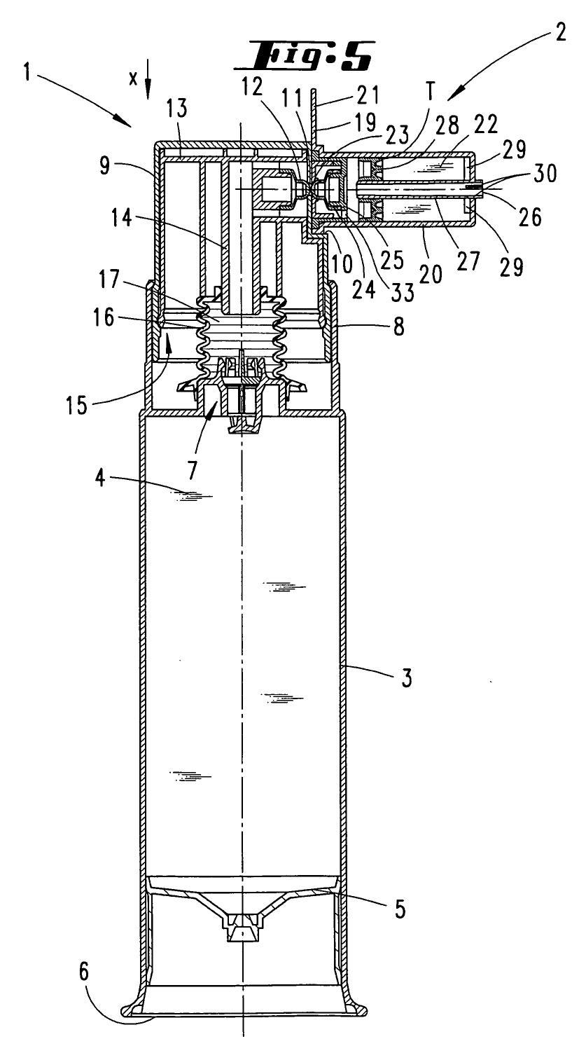

FIG. 5 shows a section along line V-V according to FIG. 3;

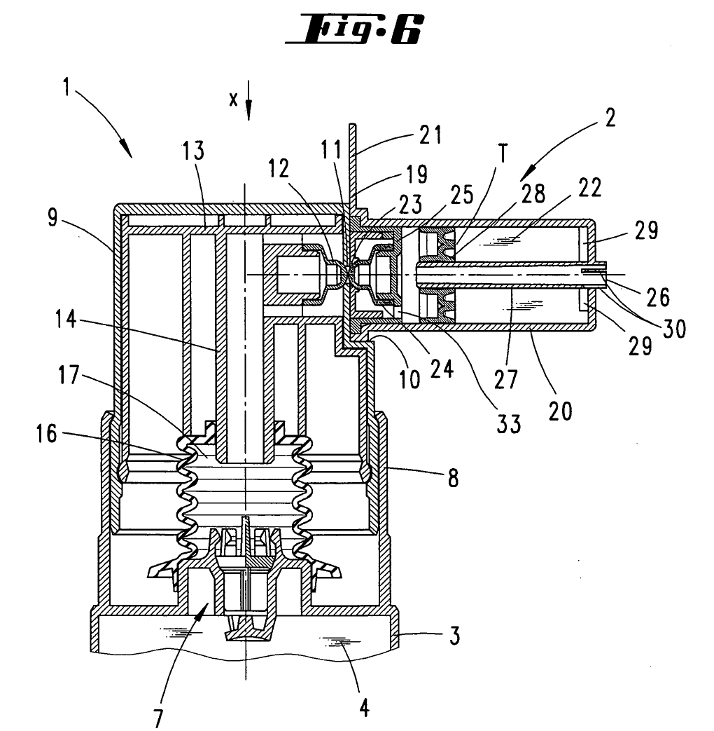

FIG. 6 shows a sectional view corresponding to FIG. 5, although in this case the upper part of the dispenser is illustrated on an enlarged scale in the form of a detail;

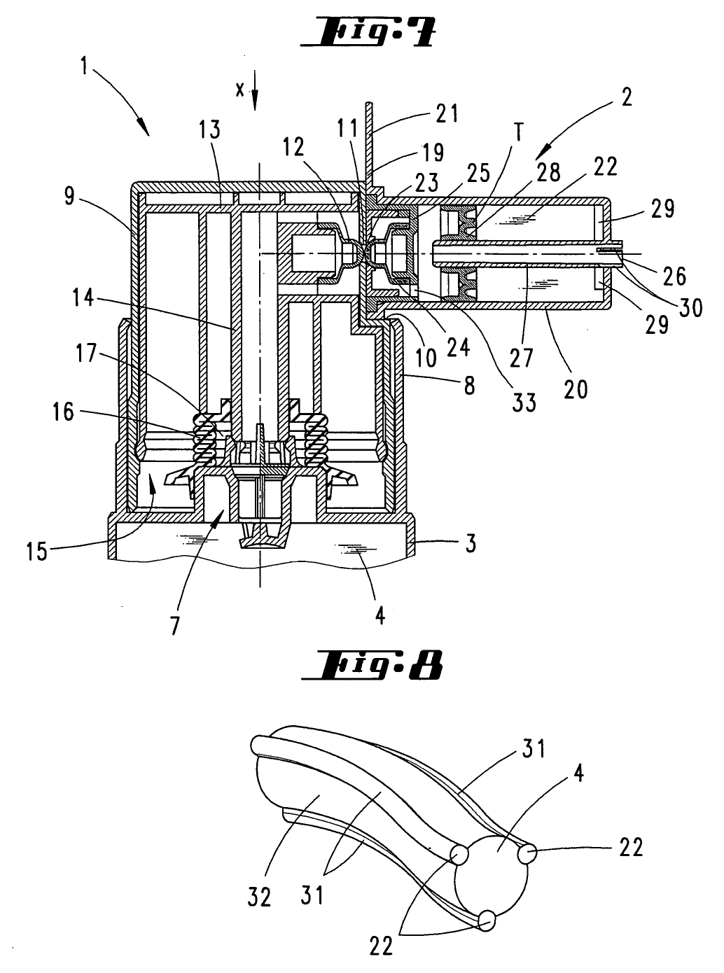

FIG. 7 shows a view corresponding to FIG. 6, although in this case the dispenser has been actuated; and

FIG. 8 shows a perspective view of a strand which has been discharged from the dispenser and comprises two different substances.

A possible configuration of a dispenser 1 with a linking receptacle 2 will be described with respect to FIGS. 1 to 7. The dispenser 1 has a first receptacle 3, which contains a first substance 4. The first receptacle 3 forms, for the purpose of accommodating the first substance 4, a storage chamber, which is closed in a known manner by a feeding piston 5. When the dispenser 1 is completely filled, the feeding piston 5 is associated with that end of the first receptacle 3 which forms a standing surface 6 for the dispenser 1. At that end of the storage chamber which is directed away from the standing surface 6, the first receptacle 3 forms a valve 7. The valve 7 is closed in the basic position of the dispenser 1. The valve 7 is enclosed by a wall 8 of the first receptacle 3. An annular space is formed between the valve 7 and the wall 8. A closure head 9 projects into the annular space between the valve 7 and the wall 8. In the end region, the closure head 9 is adapted to the internal diameter of the wall 8. In the inactive position, this region has the wall 8 overlapping it such that it is no longer possible for the closure head to be removed from the annular space. For this purpose, the wall 8 tapers at the free end and, at the same time, forms a stop for the closure head 9. The closure head 9 is accommodated by the first receptacle 3 such that the closure head 9 can be pressed down in the direction of the feeding piston 5 (arrow direction x). The closure head 9 can be displaced in arrow direction x until the free end strikes against that end region of the storage chamber which runs horizontally in the figures and in which the valve 7 is also disposed (see, in particular, FIG. 7).

It can be seen from FIG. 3 that the dispenser 1 has a substantially round cross-section. The dispenser 1 thus has a substantially cylindrical basic shape. However—as can be seen particularly from FIGS. 4, 5, 6 and 7—the closure head 9 has a stepped portion 10, on the right-hand side in the drawings. The vertically running wall of the stepped portion 10 contains a discharge opening 11 which is intended for the first substance 4 and is closed by an outlet valve 12. The outlet valve 12 is formed by a self-closing valve and is retained in a known manner by an inner head part 13 accommodated in the closure head 9.

The inner head part 13 forms a discharge tube 14, which runs in the direction of the longitudinal extent of the first receptacle 3. The inner head part 13 is fixed to the closure head 9 via a latching means 15. For this purpose, an annular bead, which is formed from the inner head part 13, engages in an annular groove which is formed, as it were, for this purpose by the closure head 9.

The free end of the discharge tube 14 is spaced apart from the valve 7 in order that the inner head part 13 can be displaced, as has already been mentioned above, in arrow direction x; the free end is likewise enclosed by an upper end of a bellows 16. The lower end of the bellows 16 encloses the seat of the valve 7. The pumping chamber 17 is formed by the bellows 16. The bellows 16 forces the closure head 9 counter to the arrow direction x and thus displaces the closure head 9 back again, following actuation, into the starting position.

As can be seen particularly from FIG. 3, the closure head 9, to the side of the stepped portion 10, forms grooves 18 which extend in the longitudinal direction of the receptacle 1. A projecting peripheral region 19 of the second, linkable receptacle 20 can be pushed into the grooves 18. As can be seen for example from FIGS. 1 and 2, the peripheral region 19 of the linking receptacle 20 projects beyond the closure head 9 and thus forms a grip portion 21. The peripheral region 19 with the grip portion 21 has a substantially rectangular footprint as seen in the viewing direction of FIG. 2. In contrast, the linking receptacle 20 is substantially of cylindrical configuration. The linking receptacle 20 may be understood as being a separate receptacle which contains a second substance 22 and can be connected to the dispenser 1.

At its end which is associated with the peripheral region 19, the linking receptacle 20 forms an inlet opening 23 which is closed by an inlet valve 24 in the form of a self-closing valve. The inlet valve 24 is accommodated by an accommodating part 25 which is disposed in the linking receptacle 20. The accommodating part 25 forms a plurality of through-openings 33 which are distributed over its circumference and through which the first substance 4, which has already passed the inlet valve 24, can be delivered. At its other end, the linking receptacle 20 forms an outlet opening 26, which is formed by a discharge tube 27. The discharge tube 27 is disposed centrally in the linking receptacle 20 and is enclosed at the end, in the direction of the inlet opening 23, by a separating body T in the form of a feeding piston 28. The separating body T or the feeding piston 28 delimits the storage chamber in the linking receptacle 20 for the second substance 22. The separating body T separates the first substance 4 from the second substance 22 spatially until they are brought into contact just before the two substances 4, 22 are discharged. The discharge tube 27 is stabilized on the inner wall of the linking receptacle 20 by crosspieces 29. These may be in the form, for example, of three crosspieces 29 which are disposed at equal angles with respect to one another around the discharge tube 27 (see FIG. 2). Furthermore, the discharge tube 27 forms slot-like apertures 30 at the end, in the direction of the discharge opening 26. These may be constituted, for example, by three apertures 30 which, in the same way as the crosspieces 29, are disposed at equal angles with respect to one another, although the apertures 30 are at an angular offset in relation to the crosspieces 29. This means that the apertures 30 and the crosspieces 29 do not coincide. The second substance 22 can enter into the discharge tube 27 through the apertures 30.

The dispenser 1, in conjunction with the linking receptacle 20, functions as follows:

As can be seen from FIG. 4, the dispenser 1 can be connected to the linking receptacle 20. For this purpose, the linking receptacle 20 has its peripheral region 19 introduced into the grooves 18 in arrow direction x. The dispenser 1 can be operated both with and without the linking receptacle 20. However, should the dispenser 1 be operated without the linking receptacle 20, then the dispenser 1 serves merely for discharge of a substance 4. In conjunction with the linking receptacle 20, however, the dispenser 1 can be used for discharge of a further substance 22 in conjunction with the first substance 4.

In FIGS. 1-6, the dispenser 1 is located in the non-operated position. If the closure head 9 is then pressed down in arrow direction x, the first substance 4, which is located in the pumping chamber 17, is pumped through the discharge tube 14, past the outlet valve 12, through the discharge opening 11. From there, the first substance 4, in the case of a linking receptacle 20 having been previously connected, passes through the inlet opening 23, past the inlet valve 24, into the linking receptacle 20. Some of the first substance 4 acts on the separating body T, in the form of the feeding piston 28, and some more of the first substance 4 is pumped through the discharge tube 27. The outlet valve 12 and the inlet valve 24 are operated by the first substance 4. Likewise, operation of the dispenser 1 forces the first substance 4 against the feeding piston 28 and displaces the latter in the direction of the discharge opening 24. The second substance 22 is thus pumped through the aperture 30 into the discharge tube 27. A strand which comprises two substances 4, 22, and is formed for example such as is illustrated in FIG. 8, is delivered out of the discharge opening 26. Through the apertures 30, small strands 31 of second substance 22 are applied to a main strand 32 of first substance 4. The number of small strands 31 on the main strand 32 depends on the number of apertures 30.

After the closure head 9 has been forced in arrow direction x, it is displaced back again by the elastic bellows 16 into the starting position (see FIGS. 1-6). As a result of the closure head 9 being displaced counter to the arrow direction x, the valve 7 opens and the first substance 4 fills the pumping chamber 17 again. As the first substance 4 penetrates into the pumping chamber 17, the feeding piston 5 also moves in known manner counter to the arrow direction x.

All features disclosed are (in themselves) pertinent to the invention. The disclosure content of the associated/attached priority documents (copy of the prior application) is hereby also included in full in the disclosure of the application, also for the purpose of incorporating features of these documents in claims of the present application.

1-15. (canceled)

16. Hand-operated dispenser (1) for paste-like to fluid substances, having a pumping chamber (17) and at least one outlet valve (12) and also a storage chamber with a feeding piston (5), the dispenser (1) being configured for dispensing two different substances, a first substance (4) and a second substance (22), the second substance (22) being dispensed by the pressure of the first substance (4), a movable separating body (T) being disposed between the first substance (4) and second substance (22), and the first substance (4) being accommodated in a first receptacle (3) and the second substance (22) being accommodated in a second receptacle (20), wherein the second receptacle, which is formed as a linking receptacle (20) and can be connected to the dispenser (1) without the pumping chamber of the dispenser (1) being altered, has a discharge tube (27) passing through the separating body (T).

17. Dispenser according to claim 16, wherein the linking receptacle (20) has an inlet valve (24).

18. Dispenser according to claim 16, wherein the second substance (22) is introduced into the first substance (4) downstream of the outlet valve (12).

19. Dispenser according to claim 16, wherein the separating body (T) is in the form of a feeding piston (28).

20. Dispenser according to claim 16, wherein the separating body (T) can be displaced relative to the discharge tube (27).

21. Dispenser according to claim 16, wherein the inlet valve (24) and/or the outlet valve (12) are/is formed as an elastic self-closing valve.

22. Dispenser according to claim 21, wherein both the outlet valve (12) and the inlet valve (24) can be operated by the pressure of the first substance (4).

23. Dispenser according to claim 16, wherein the linking receptacle (20) can be connected to the first receptacle (3) by a push-in connection.

24. Linking receptacle (20) for linking to a dispenser (1) having paste-like to fluid substance, the linking receptacle (20) containing the second substance (22) and having an inlet opening (23) and an outlet opening (26) and also a separating body (T), comprising the provision of a discharge tube (27) passing through the separating body (T).

25. Linking receptacle according to claim 24, wherein at least the inlet opening (23) is closed by a valve.

26. Linking receptacle according to claim 24, wherein the separating body (T) can be displaced in the direction of discharge.

27. Linking receptacle according to claim 26, wherein the separating body (T) is in the form of a feeding piston.
